(19) United States
(12) Patent Application Publication
(10) Pub. No.: US 2003/0136626 A1
(43) Pub. Date: Jul. 24, 2003

(54) Magneto-rheological clutch assembly for use in an electromechanical system

(76) Inventors: Dina A. Ciaramitaro, Shelby Township, MI (US); David A. Sedlak, Clarkston, MI (US)

Correspondence Address: Kathryn A. Marra, Delphi Technologies, Inc., P.O. Box 5052, Troy, MI, 48007-5052, US

(21) Appl. No.: 10/055,428

(22) Filed: Jan. 23, 2002

(51) Int. Cl. F16D 37/02

(52) U.S. Cl. 192/57; 192/21.5

(57) ABSTRACT

A magneto-rheological clutch assembly for use in an electromechanical system. The clutch assembly includes a motor having a shaft that is coupled to a magneto-rheological clutch. There is also included a gear plate that is attached to the clutch, as well as being connected to a contact plate and pinion gear. The pinion gear engages a corresponding connection of a power operator system. The magneto-rheological clutch prevents damage to the motor power operator system and panel by simulating a slipping condition when a load exceeding a specified tolerance is applied to the panel.

### FIELD OF THE INVENTION

The invention relates to a magneto-rheological fluid clutch for power product applications. With more particularity, the invention relates to a magneto-rheological fluid clutch that simulates a slipping condition for preventing damage to a power operator system and the panel it drives.

### BACKGROUND OF THE INVENTION

Power operators are utilized in the art for opening and closing panels such as a liftgate, power sliding door, deck lid, or other such panels. Generally, clutches are associated with the power operator to selectively transfer torque from a motor to move the panel along a travel path.

It is known in the art to utilize electromagnetic clutches that generally include a housing and a friction plate. Within the housing there is a clutch coil that is energized when a current is applied to engage the clutch. The friction plate and the housing are coupled due to the magnetic attraction that occurs. The friction plate is generally a ferrous plate that couples to the housing and thereby transfers torque from the motor.

There are problems associated with the use of electromagnetic clutches in a power operator system. One problem is that excessive wear occurs on the surfaces of the friction plate and housing due to slipping of the clutch. The wear decreases the performance of the clutch and also contributes to a shorter service life for a power operating system. Another problem is that it is difficult to duplicate the slipping performance of a clutch as there are variations associated with such electromagnetic clutches due to manufacturing tolerances.

Because of the limited nature of having an electromagnetic clutch that is either engaged or disengaged, there is a need in the art for advanced control of a clutch mechanism that provides greater options than a binary mode clutch.

Advanced control of a clutch mechanism could be utilized to prevent damage to a power operator system and panel. For example, a user may exert an abrupt abusive load in an attempt to reverse the direction of a power operator system such as in a power operated liftgate. If an electromagnetic clutch were being utilized in this situation, the power operator system would not be able to disengage the clutch fast enough. This could possibly lead to permanent damage of the power operator and panel.

Therefore, there is a need in the art for a power operator system that includes ! a clutch mechanism with advanced control, such that the clutch may simulate a slipping condition without actually slipping and leading to the frictional wear that is commonly associated with electromagnetic clutch systems.

### SUMMARY OF THE INVENTION

A magneto-rheological clutch assembly that is used in an electromechanical system. The motor/clutch assembly includes a motor having a shaft, and a magneto-rheological clutch that is coupled to the shaft. The magneto-rheological clutch includes a magneto-rheological fluid that is contained within the clutch. There is also included a gear plate that is attached to the clutch and a contact plate that is connected to the gear plate. A pinion gear is connected to the gear plate for engaging a corresponding connection of a power operator system. There is also included a panel that is in communication with the corresponding connection of the power operator system. The panel is movable along a path. The magneto-rheological clutch prevents damage to the motor and power operator system and panel by simulating a slipping condition when a load exceeding a specified tolerance is applied to the panel.

The magneto-rheological clutch assembly of the present invention has the advantage of providing a clutch that simulates a slipping behavior without actually slipping as in a conventional electromagnetic clutch.

The magneto-rheological clutch assembly of the present invention also has the advantage of providing a clutch that provides a variable clutch resistance by changing the voltage supplied to the clutch coil; thereby changing the rheological properties of the magneto-rheological fluid.

The magneto-rheological clutch assembly also has the advantage of providing a clutch that is ready to use without burnishing or other preparatory conditioning as is often required with conventional electromagnetic clutches.

Additionally, the magneto-rheological clutch assembly of the present invention when used in a power operator system allows for a panel to be stopped along its travel path when an object impedes the travel path of the panel without exerting a significant force upon the object.

### BRIEF DESCRIPTION OF THE DRAWINGS

These and other features and advantages of the present invention will become more readily appreciated when considered in connection with the following detailed description and appended drawings, where:

FIG. 1 is an environmental view of the clutch assembly as utilized in a power operated liftgate;

FIG. 2 is an enlarged cut away perspective view of the clutch assembly as utilized in a power operated liftgate;

FIG. 3 is an exploded assembly view detailing the motor/clutch assembly of the present invention;

FIG. 4 is a sectional view detailing the clutch of the present invention.

### DETAILED DESCRIPTION OF THE INVENTION

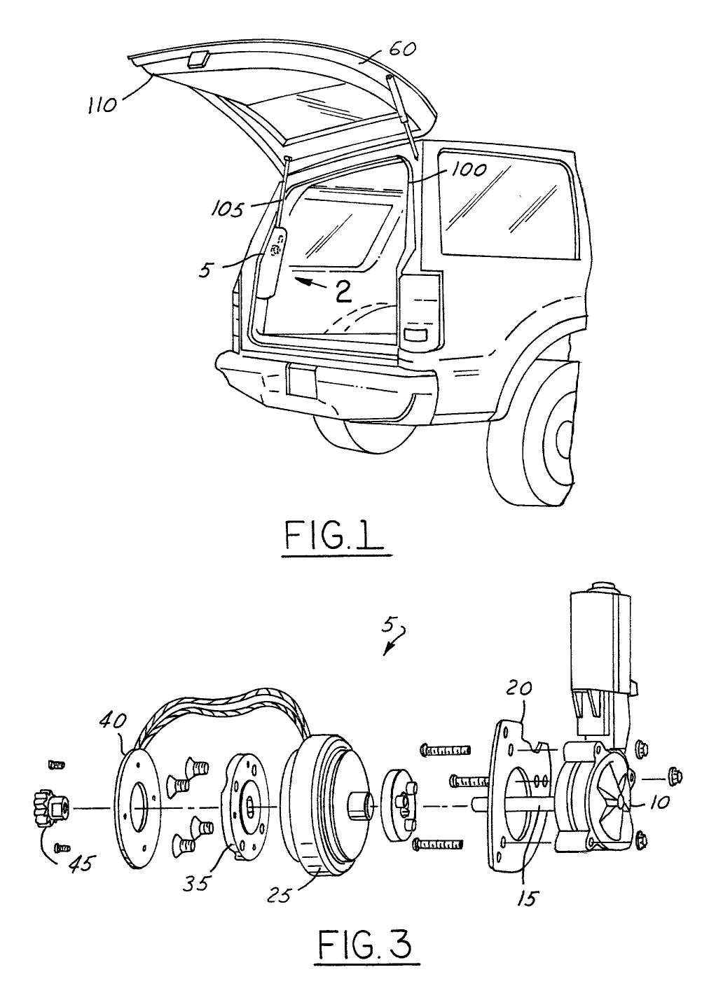

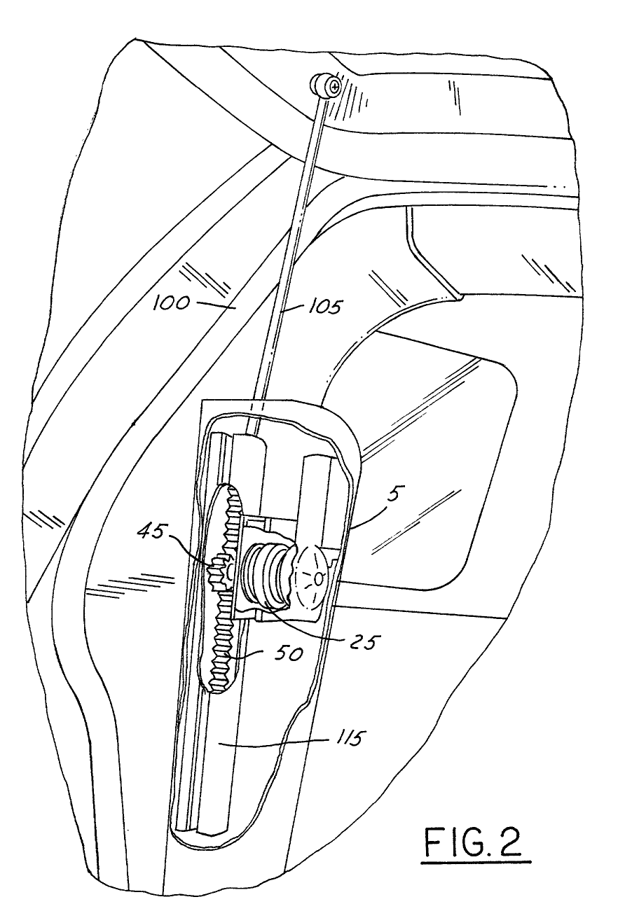

With reference to FIG. 3, there is shown the magneto-rheological clutch assembly 5 of the present invention. The magneto-rheological clutch assembly 5 includes a motor 10 that has a shaft 15 associated therewith. The motor 10 may be mounted utilizing alternative means including snap-fit retention devices, slots, or other alternative fastening means commonly used in the art.

Again, with reference to FIG. 3, the magneto-rheological motor/clutch assembly 5 includes a magneto-rheological clutch 25 that is coupled to the shaft 15 associated with the motor 10. The magneto-rheological clutch 25 includes a magneto-rheological fluid 30 contained therein which will be discussed in further detail below.

The magneto-rheological motor/clutch assembly 5 also includes a gear plate 35 that is attached to the magneto-rheological clutch 25. A contact plate 40 supplies power to the magneto-rheological clutch 25 and is connected to the gear plate 35. A pinion gear 45 is connected to the gear plate 35 and generally engages a corresponding connection 50 of a power operating system.

A power operating system, as the term is used in this specification, refers to any number of systems commonly associated with motor vehicles including, power operated liftgates, power operated sliding doors, power operated deck lids, power operated swing doors, and other electromechanical systems that move a panel from one position to another.

The magneto-rheological motor/clutch assembly 5 of the present invention also includes a panel 60 in communication with the corresponding connection 50 of the power operator system. The panel 60 is movable along a path from a first position to a second position and vice versa. The magneto-rheological clutch 25 prevents damage to the motor 10, power operator system and panel 60 by simulating a slipping condition when a load exceeding a specified tolerance is applied to the panel 60.

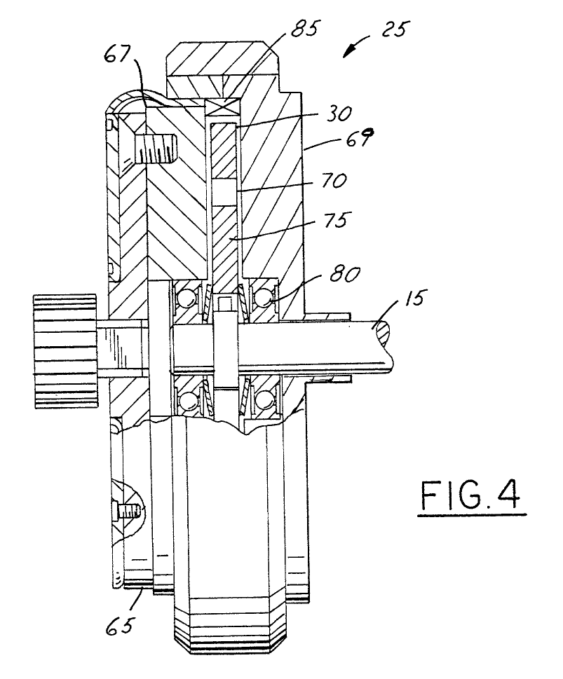

With reference to FIG. 4, there is shown the magneto-rheological clutch 25 of the present invention. As can be seen, the magneto-rheological clutch 25 includes a housing 65 that receives the shaft 15. The housing 65 is generally made of identical first and second halves that have a hollowed out section formed on the interior. Each half 67, 69 includes a hollowed out section which together form a hollowed out cavity 70. Within the hollow cavity 70, there is contained a rotor 75 that is supported by bearings 80. The magneto-rheological fluid 30 is placed adjacent the rotor 75 and within the hollow cavity 70 in the housing. The yield stress of the magneto-rheological fluid varies due to the strength of the coil's magnetic field. A stronger magnetic field increases the yield stress of the magneto-rheological fluid thereby increasing the lockup torque of the clutch.

Again with reference to FIG. 4, it cain be seen that an electromagnetic coil 85 surrounds the hollow cavity 70 and has a magnetic flux density that is induced by the current supplied to the coil. As power is supplied to the magneto-rheological clutch 25 via the contact plate 40, the rheological properties of the magneto-rheological fluid 30, which contains ferromagnetic particles such as iron spheres, will vary according to the magnetic flux density of the fluid 30.

The magneto-rheological clutch 25 can simulate a slipping condition by varying the magnetic flux density of the coil 85 such that the magneto-rheological fluid shears when a load exceeding a specified tolerance is applied to the panel 60 In this manner, torque is not transferred from the motor 10 to the pinion gear 45, thereby preventing damage to the power operator system and panel 60. The simulated slipping condition does not cause frictional wear to components as with a conventional electromagnetic clutch design.

Generally, the specified tolerance or load which can be applied to the magneto-rheological clutch wherein a slipping condition is generated will vary dependent on the application being utilized. The magnetic flux density of the fluid that accompanies the specified tolerance associated with the liftgate is from 0.5 to 2.0 Tesla

With reference to FIGS. 1 and 2, there is shown an environmental view of the motor/clutch assembly 5, utilized in a power liftgate application.

As can be seen from FIG. 1, the motor/clutch assembly 5 is preferably attached to the substructure surrounding a liftgate opening 100. The motor/clutch assembly 5 includes a motor 10 that transfers torque through the magneto-rheological clutch 25 to the liftgate power operator system. The power operator system of the liftgate generally includes a strut 105 that moves the liftgate 110 from an open to a closed position. Associated with the strut is a track mechanism 115 that engages the strut 105 and moves it from an open to a closed position.

If an object was to be placed within the liftgate opening 100 such that it interfered with the closure of the liftgate, the use of the motor/clutch assembly 5 would allow for the liftgate travel to be halted by simulating a slipping condition such that the magneto-rheological fluid within the magneto-rheological clutch 25 shears. In this manner, the object blocking the travel path of the liftgate would not have significant forces placed on it, as the magneto-rheological fluid 30 would shear rather than transfer torque from the motor 10. This arrangement provides a reliable system to prevent power operated systems from closing on an undesired object, and applying an undesired force on the object. The magneto-rheological clutch disengages the motor from the power operator system thereby allowing the motor to continue spinning without transferring torque to the panel.

While a preferred embodiment is disclosed, a worker in this art would understand that various modifications would come within the scope of the invention. Thus, the following claims should be studied to determine the true scope and content of the invention.

What is claimed is:

1. A motor/magneto-rheological clutch assembly for use in an electromechanical system comprising:
a) a motor including a shaft;
b) a magneto-rheological clutch coupled to the shaft, the magneto-rheological clutch having a magneto-rheological fluid contained therein;
c) a gear plate attached to the magneto-rheological clutch;
d) a contact plate connected to the gear plate;
e) a pinion gear connected to the gear plate for engaging a corresponding connection of a power operator system;
f) a panel in communication with the corresponding connection of the power operator system, the panel being movable along a path;
the magneto-rheological clutch preventing damage to the motor power operator system and panel by simulating a slipping condition when a load exceeding a specified tolerance is applied to the panel.

2. The motor/magneto-rheological clutch assembly of claim 1 wherein the magneto-rheological clutch simulates a slipping condition in that the magneto-rheological fluid contained in the magneto-rheological clutch shears when a force is applied exceeding a specified tolerance, thereby stopping the transfer of torque from the motor.

3. The motor/magneto-rheological clutch assembly of claim 1 wherein a magnetic flux density of the coil is variable by adjusting the input voltage to the magneto-rheological clutch.

4. The motor/magneto-rheological clutch assembly of claim 3 wherein the magnetic flux density of the coil is adjusted such that the magneto-rheological fluid shears when a force exceeding a specified tolerance is applied to the panel.

5. The motor/magneto-rheological clutch assembly of claim 1 wherein the magneto-rheological clutch assembly further includes a coupler for coupling the magneto-rheological clutch to the shaft.

6. The motor/magneto-rheological clutch assembly of claim 1 wherein the contact plate allows for the transfer of power to the magneto-rheological clutch.

7. The motor/magneto-rheological clutch assembly of claim 1 wherein the power operator system operates a power liftgate.

8. The motor/magneto-rheological clutch assembly of claim 1 wherein the power operator system operates a power sliding door.

9. The motor/magneto-rheological clutch assembly of claim 1 wherein the power operator system operates a power deck lid.

10. The motor/magneto-rheological clutch assembly of claim 1 wherein the power operator system operates a power swing door.

11. The motor/magneto-rheological clutch assembly of claim 1 wherein the panel stops travel along its path when an object impedes the travel path thereby causing a load to be placed on the panel exceeding the specified tolerance.

12. The magneto-rheological clutch assembly of claim 3 wherein the magnetic flux density is from 0.5 to 2.0 Tesla.

13. A motor/magneto-rheological clutch assembly for use in an electromechanical system comprising:
a) a motor including a shaft;
b) a magneto-rheological clutch coupled to the shaft, the magneto-rheological clutch having a magneto-rheological fluid contained therein;
c) a gear plate attached to the magneto-rheological clutch;
d) a contact plate connected to the gear plate;
e) a pinion gear connected to the gear plate for engaging a corresponding connection of a power operator system;
f) a panel in communication with the corresponding connection of the power operator system, the panel being movable along a path;
the magneto-rheological clutch preventing damage to the motor power operator system and panel by simulating a slipping condition in that the magneto-rheological fluid contained in the magneto-rheological clutch shears when a force is applied exceeding a specified tolerance, thereby stopping the transfer of torque from the motor.
